(19) United States
(12) Patent Application Publication
(10) Pub. No.: US 2008/0310474 A1
(43) Pub. Date: Dec. 18, 2008

(54) SQUARE MICRO-CAVITY LASER WITH AN OUTPUT WAVEGUIDE

(76) Inventors: Yongzhen Huang, Beijing (CN); Wei Zhao, Beijing (CN)

Correspondence Address: WESTMAN CHAMPLIN & KELLY, P.A., SUITE 1400, 900 SECOND AVENUE SOUTH, MINNEAPOLIS, MN, 55402-3244, US

(21) Appl. No.: 12/137,783

(22) Filed: Jun. 12, 2008

(30) Foreign Application Priority Data
Jun. 15, 2007 (CN) 200710118937.9

(51) Int. Cl. H01S 3/06

(52) U.S. Cl. 372/66

(57) ABSTRACT

A square micro-cavity laser with an output waveguide comprises: a substrate; a resonator, which has a square shape and is fabricated on the substrate; a stripe output waveguide, which is fabricated on the substrate and is connected to the midpoint of one side face of the resonator; wherein the area of the resonator or the stripe output waveguide is less than that of the substrate.

### BACKGROUND OF THE INVENTION

1. Field of Invention

The present invention relates to a micro-cavity laser, more particularly to a square micro-cavity laser with a stripe output waveguide, wherein the stripe output waveguide enables the micro-cavity laser to realize directional output and single-mode emission.

2. Description of Prior Art

With the progress and reformation of the modern information technology, optoelectronic devices gradually develop to high integration density, high efficiency, low power consumption and miniaturization. However, it is difficult for most of conventional semiconductor lasers to realize all these purposes. An optical micro-cavity has the strong limitation to the optical field through a total internal reflection. A Whispering-Gallery (WG) mode having an extremely high Quality factor (Q-factor) is generated in the cavity, which has the advantages of small mode volume, low power consumption, ultra fast response and extremely low noise and is suited to fabricate a micro-cavity laser and an array thereof with an extremely low threshold value and high density integration. The optical micro-cavity is widely used in aspects of optical integration, optical interconnection, optical communication and optical neural network. But the micro-cavity laser which is represented by micro-disk laser is difficult to obtain directional output due to its high symmetry and the output power of the micro-cavity laser is very low. It is an essential condition for the micro-cavity laser to be commercially applied that the micro-cavity laser can realize directional optical power output.

A square micro-cavity has a lower symmetry with respect to the micro-disk resonator cavity, in which there are several modes comprising WG mode, wherein the quality factors of the zero order mode and the first order mode are far higher than those of other WG modes and non-WG mode.

### SUMMARY OF THE INVENTION

The objective of the present invention is to provide a square micro-cavity laser with an output waveguide, the output waveguide of which can realize a directional optical power output with a high efficiency in the first order WG mode, and which enables a single micro-cavity laser to realize a single-mode emission. The present invention can realize a micro-cavity laser with a directional optical output, which has a low threshold value and high integration density.

The present invention provides a square micro-cavity laser with an output waveguide, characterized in that it comprises:

a substrate;

a resonator, which has a square shape and is fabricated on the substrate;

a stripe output waveguide, which is fabricated on the substrate and is connected to the midpoint of one side face of the resonator;

wherein, the area of the resonator or the stripe output waveguide is less than that of the substrate.

Preferably, said resonator comprises:

a lower cladding layer, which is connected to the substrate;

an active layer, which is fabricated on the lower cladding layer and the shape of which is identical to that of the lower cladding layer;

an upper cladding layer, which is fabricated on the active layer and the shape of which is identical to that of the lower cladding layer.

Preferably, said stripe output waveguide is a single-mode waveguide or a multimode waveguide, and the width of said stripe output waveguide is less than ½ of a side length of the resonator.

Preferably, the structure and material of said stripe output waveguide is identical to or different from the structure and material of the resonator.

Preferably, the projection shapes of the angle between the adjacent side faces of the resonator and the angle between the stripe output waveguide and the resonator at their joints are a right angle, or an arc rounded angle or an incisal angle.

Preferably, the area of the arc rounded angle or the incisal angle is not more than 1/16 of that of the cross-section of the resonator.

### BRIEF DESCRIPTION OF THE DRAWINGS

The above objects, advantages and features of the present invention will be apparent from the following detailed description on the preferred embodiments taken conjunction with the drawings in which:

FIG. 1 is a schematic view of the structure of the square micro-cavity laser with an output waveguide (top view).

FIGS. 2a and 2b are schematic views of the spatial structure of the square micro-cavity laser with an output waveguide, wherein the material structures of the stripe output waveguide 3 and the resonator 2 are the same in FIG. 2a and different from each other in FIG. 2b.

FIG. 3 shows the cross section view of various projection shapes of the angle between the adjacent side faces of the resonator 2 and the angle between the stripe output waveguide 3 and the resonator 2 at their joints.

FIG. 4 is a graph showing the Q factors of the fundamental mode and the first order mode of the square micro-cavity obtained by numerical calculation using a two-dimensional finite-difference time-domain (FDTD) method, wherein the side length of the resonator is 4 μm, the refractive index within the resonator is 3.2 and the refractive index out of the resonator is 1.

FIG. 5 is a graph showing the output coupling efficiency of the TM_{9,13} and TM_{10,14} in the square micro-cavity with a side length of 4 μm as a function of the width of the waveguide.

### DETAILED DESCRIPTION OF PREFERRED EMBODIMENTS

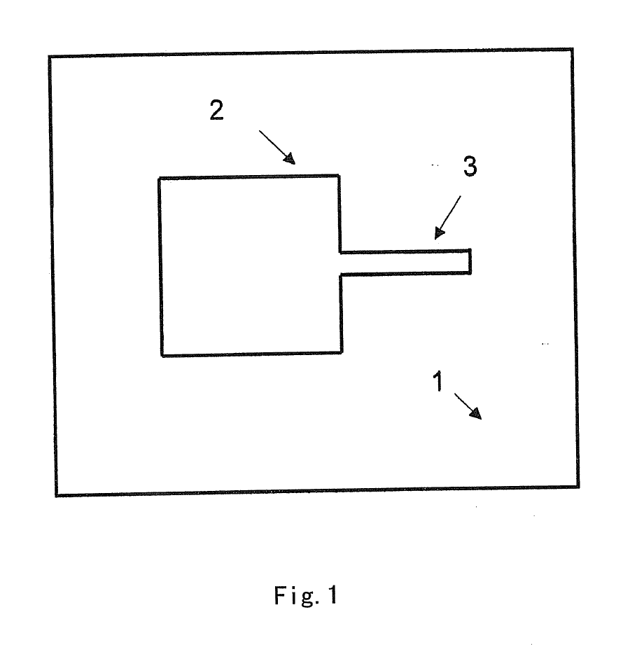

Now, the present invention will be described in detail by referring to the accompany FIGS. 1-5.

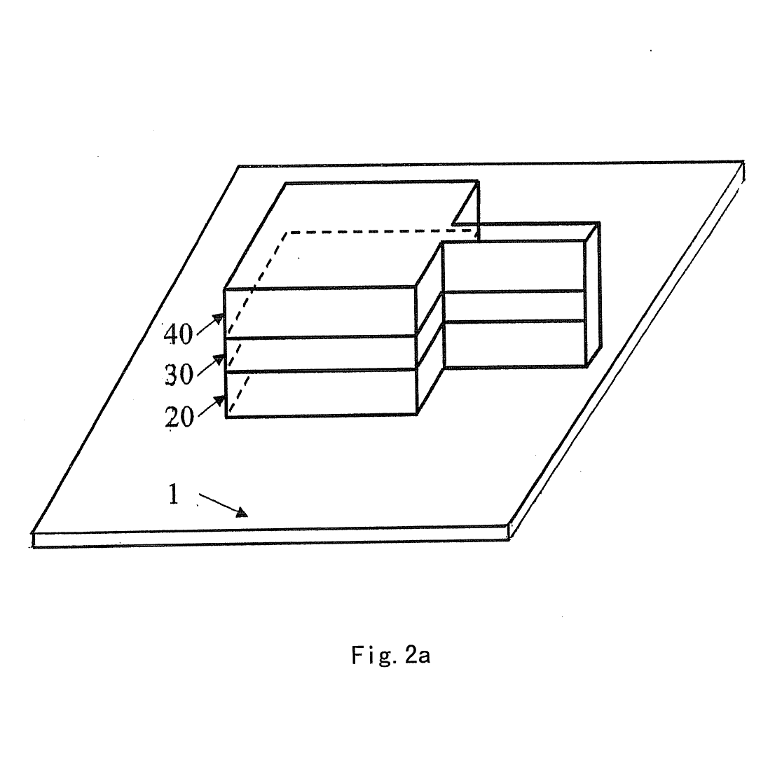

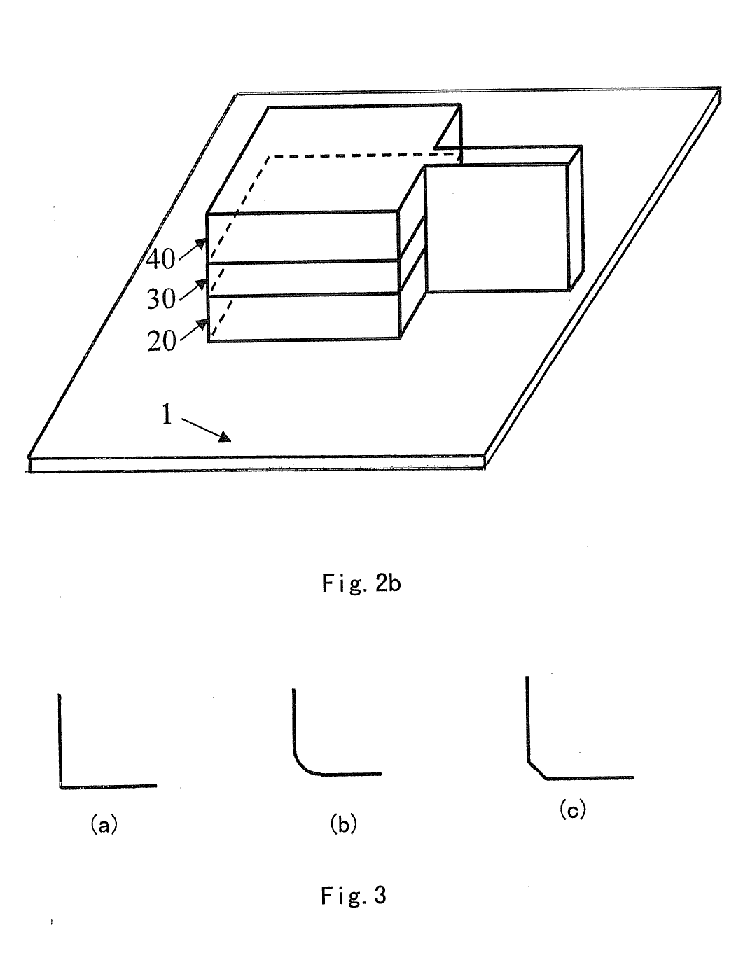

As shown in FIGS. 1, 2a and 2b, the present invention provides a square micro-cavity laser with an output waveguide comprising:

a substrate 1, the upper side of which is a resonator 2 with a stripe output waveguide 3;

wherein, the resonator 2 is fabricated on the substrate 1;

the stripe output waveguide 3 is fabricated on the substrate 1 and is connected to the midpoint of one side face of the resonator 2;

wherein, the projection shape of the resonator 2 along the direction perpendicular to the direction of the substrate 1 is a square column structure, the cross section of the resonator 2 is a square, and the difference between the side length of the adjacent sides is not more than 20% at most, the resonator 2 comprises: a lower cladding layer 20, which is connected to the substrate 1; an active region 30, which is fabricated on the lower cladding layer 20 and the shape of which is identical to that of the lower constraint layer; an upper cladding layer 40, which is fabricated on the active region 30 and the shape of which is identical to that of the lower cladding layer 20.

The stripe output waveguide 3 is located at the midpoint of one side of the resonator 2 and it is a single-mode waveguide or a multimode waveguide. The width of the stripe output waveguide 3 is not larger than ½ of a side length of the resonator 2. The stripe output waveguide 3 may have the same structure and material as the structure and material of the resonator 2, or the stripe output waveguide 3 may have different structure and material.

The projection shapes of the angle between the adjacent side faces of the resonator 2 and the angle between the stripe output waveguide 3 and the resonator 2 at their joints may be a right angle (FIG. 3a) or an arc rounded angle (FIG. 3b) or an incisal angle (FIG. 3c). The area of each arc rounded angle or each incisal angle is not more than 1/16 of that of the cross-section of the resonator 2.

Referring back to FIGS. 2a and 2b which show two embodiments of the present invention, the square micro-cavity laser of the present invention consists of a resonator 2 and a stripe output waveguide 3. The resonator 2 and the stripe output waveguide 3 are fabricated on the substrate 1. The resonator is a planar waveguide structure formed of a lower cladding layer 20, an active region 30 and an upper cladding layer 40. The thickness of the respective layer is not limited and in the actual process it may be adjusted according the requirement. The material around the resonator 2 and the output waveguide 3 is a material with a low refractive index (including air). The projection shape of the resonator along the direction perpendicular to the direction of the substrate 1 is a square column shape, the cross section of which preferably is a square. If the side lengths of the two adjacent sides of the resonator 2 take different values, the resonator 2 is a rectangular resonator. The side length of the resonator 2 is several or thousands times of the lasing wavelength. The material of the resonator may be various well known compound semiconductor materials of III-V group, and may be the semiconductor material of II-VI and IV group's compounds. It also may be an organic semiconductor material and an active material for other solid state lasers. The active region of the resonator may be a variety of structures, such as semiconductor bulk material, quantum well, quantum line, quantum dot and quantum cascaded structures. In the embodiments, the substrate 1, lower cladding layer 20, and upper cladding layer 40 are not necessary, as long as it is possible to form a lasing square resonator 2.

In the particular fabricating process, the resonator 2 may be formed by etching an epitaxial wafer into the lower cladding layer or the substrate through a dry etching or wet chemically etching techniques and the un-etched square region serves as the resonator 2. A stripe output waveguide 3 is connected or coupling to the midpoint of one side face of the square resonator 2. The stripe output waveguide 3 and the resonator 2 may be fabricated at the same time and they have the same material and structure, as shown in FIG. 2a. But the resonator 2 may be fabricated first, and then other waveguide materials are grown and etched to form an output waveguide with a different material and structure from those of the resonator, as shown in FIG. 2b. The stripe output waveguide 3 is a single-mode waveguide or a multimode waveguide. The width of the stripe output waveguide 3 is not larger than ½ of a side length of the resonator 2. The function of the output waveguide 3 is to directionally output the laser of the resonator 2. The length of the output waveguide 3 is not limited, one end of which is connected to the resonator and the other end may be integrated to other optoelectronic devices.

As shown in FIG. 3, the projection shape of the angle between the adjacent side faces of the resonator and the angle between the stripe output waveguide 3 and the resonator 2 at their joints may be a right angle (FIG. 3a), an arc rounded angle (FIG. 3b) or an incisal angle (FIG. 3c). The area of each arc rounded angle or each incisal angle is not more than 1/16 of that of the cross-section of the resonator 2.

The laser resonator 2 of the present invention may achieve lasing in a well known optically pumped mode or an electrically injected mode (the electrodes may be fabricated under the substrates 1 and on the upper cladding layer 40 with a thin ohmic contacting layer).

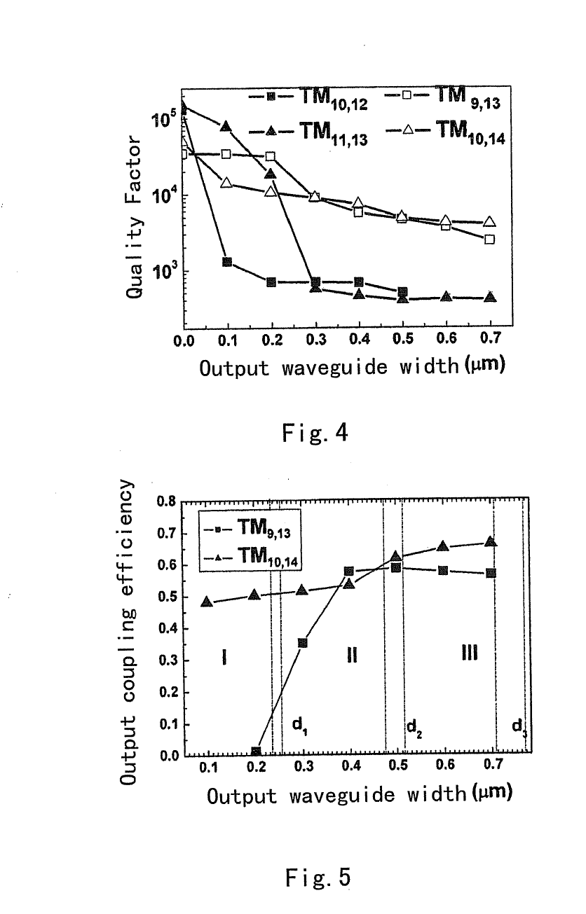

FIG. 4 is a graph showing the Q factors of the zero order mode and the first order WG mode in the square micro-cavity obtained by numerical calculation using a two-dimensional finite-difference time-domain (FDTD) method, wherein the side length of the resonator is 4 μm, the refractive index within the resonator is 3.2 and the refractive index out of the resonator is 1. The fundamental WG mode and the first order WG mode in the square resonator have a very high Q-factor, and the Q-factor of other modes is far less than that of these two modes. TM_{10,12} and TM_{11,13} are the fundamental WG modes, and TM_{9,13} and TM_{10,14} are the first order WG modes. The wavelengths of these modes are near 1.5 μm. It is indicated from the calculating results that if the width of the output waveguide is larger than the cut-off width of the first order transverse mode d₁, the Q-factors of all the fundamental WG modes are less than the Q-factor of the first order WG mode in its numeric value by one order of magnitude. The square micro-cavity laser with such structure has good mode selectivity, which makes that the first order WG mode in the square micro-cavity becomes the mode with the highest Q-factor. A directional light output can be obtained by coupling this mode into the output waveguide.

FIG. 5 is a graph showing the output coupling efficiencies of the first WG modes TM_{9,13} and TM_{10,14} as a function of the width of the waveguide. The output coupling efficiency is defined as the ratio of the optical power output outwards from the output waveguide to the optical power radiated outwards from the entire resonator. d₁, d₂ and d₃ are the cut-off widths of the first order, the second order and the third order transverse modes in a symmetrical stripe waveguide, respectively. Each pair of the adjacent dashed lines corresponds to TM_{9,13} and TM_{10,14} modes, and the cut-off widths of each order transverse mode divide the figure into three parts of I, II and III. The first order WG mode TM_{10,14}, which is symmetrical about the perpendicular bisector of the opposite sides of the square, has an output efficiency of about 50% even in a case where the width of the output waveguide is small. It is coupled into the output waveguide to be present in form of even order transverse modes. The first order WG mode TM_{9,13}, which is anti-symmetric about the perpendicular bisector of the opposite sides of the square, is coupled into the output waveguide to be present in form of odd order transverse modes. Because there is a cut-off width in the waveguide for the odd order transverse modes, the odd order transverse modes can be coupled to the output waveguide and may obtain high output efficiency only if the width of the output waveguide is larger than the cut-off width of the first order transverse mode. Their output coupling efficiencies increase as the width of the output waveguide increases.

What is claimed is:

1. A square micro-cavity laser with an output waveguide, comprising:
a substrate;
a resonator, which has a square shape and is fabricated on the substrate;
a stripe output waveguide, which is fabricated on the substrate and is connected to the midpoint of one side face of the resonator;
wherein the area of the resonator or the stripe output waveguide is less than that of the substrate.

2. The square micro-cavity laser with an output waveguide according to claim 1, wherein said resonator comprising:
a lower cladding layer, which is connected to the substrate;
an active region, which is fabricated on the lower cladding layer and the shape of which is identical to that of the lower cladding layer;
an upper cladding layer, which is fabricated on the active region and the shape of which is identical to that of the lower cladding layer.

3. The square micro-cavity laser with an output waveguide according to claim 1, wherein said stripe output waveguide is a single-mode waveguide or a multimode waveguide, and the width of said stripe output waveguide is less than ½ of a side length of the resonator.

4. The square micro-cavity laser with an output waveguide according to claim 1, wherein the structure and material of said stripe output waveguide are identical to or different from the structure and material of the resonator.

5. The square micro-cavity laser with an output waveguide according to claim 1, wherein the projection shapes of the angle between the adjacent side faces of the resonator and the angle between the stripe output waveguide and the resonator at their joints are a right angle, or an arc rounded angle or an incisal angle.

6. The square micro-cavity laser with an output waveguide according to claim 5, wherein the area of the arc rounded angle or the incisal angle is not more than 1/16 of that of the cross-section of the resonator.
